(19) United States
(12) Patent Application Publication
(10) Pub. No.: US 2015/0163133 A1
(43) Pub. Date: Jun. 11, 2015

(54) LOAD SHARING OF MPLS PSEUDO-WIRES

(71) Applicants: Donald B. Grosser, Apex, NC (US); Olen Stokes, Cary, NC (US); Victor E. Pickard, Hillsborough, NC (US); Venugopalan Ullanatt, Cary, NC (US)

(72) Inventors: Donald B. Grosser, Apex, NC (US); Olen Stokes, Cary, NC (US); Victor E. Pickard, Hillsborough, NC (US); Venugopalan Ullanatt, Cary, NC (US)

(21) Appl. No.: 14/565,338

(22) Filed: Dec. 9, 2014

Related U.S. Application Data
(60) Provisional application No. 61/913,836, filed on Dec. 9, 2013.

(51) Int. Cl. H04L 12/723; H04L 12/713; H04L 12/46; H04L 12/721

(52) U.S. Cl. CPC H04L 45/50; H04L 45/44; H04L 45/586; H04L 12/462

(57) ABSTRACT

A first switch at a first edge of an MPLS network establishes a VPLS pseudo-wire over a plurality of label switched paths (LSPs) of the MPLS network that couple the first switch to a second switch at a second edge of the MPLS network. The first switch further load balances data to be transmitted across the VPLS pseudo-wire over the plurality of LSPs. The first switch accomplishes this by maintaining at a first table an indication that the VPLS pseudo-wire traffic is to be transmitted over the plurality of LSPs and further identifying in the first table a pointer to a second table maintaining a plurality of LSP entries corresponding to the respective plurality of LSPs. The first switch then identifies at the second table a pointer to a third table maintaining a plurality of entries, wherein each of the plurality of entries identifies a next hop index. The first switch receives a packet to be transmitted over the VPLS pseudo-wire, computes a hash value on at least one or more portions of the received packet, selects one of the plurality of entries in the third table according to the computed hash value, retrieves the next hop index from the selected one of the plurality of entries in the third table, selects an entry in a fourth table according to the retrieved next hop index, and retrieves from the selected entry in the fourth table an egress port number associated with an egress port to which the received packet is to be directed for transmission across the VPLS pseudo-wire.

### RELATED APPLICATION

This application claims the benefit of U.S. Provisional Application No. 61/913,836, filed Dec. 9, 2013, the entire disclosure of which is incorporated herein by reference.

### FIELD

Embodiments of the invention relate to computer networking, and more particularly to load sharing of MPLS pseudo-wires.

### BACKGROUND

VPLS (Virtual Private LAN Service) is a layer 2 VPN technology based on MPLS (Multiprotocol Label Switching). VPLS provides a way to connect geographically disperse Ethernet provider edge (PE) sites over an MPLS network using pseudo-wires. The current offering of VPLS by the assignee of the present patent application using third party chipsets allows a VPLS pseudo-wire to be established over a single Tunnel LSP (Label Switched Path). This approach has the following shortcomings:

1.) An ingress node that originates a VPLS pseudo-wire is unable to distribute traffic over multiple paths available to the VPLS peer. In deployments that have very few pseudo-wires, this shortcoming is reflected throughout the network since the intermediate nodes are not able to distribute traffic. The intermediate nodes depend on the ability of the ingress nodes to distribute traffic for them.

2.) If the LSP over which the pseudo-wire rides fails or goes down, the pseudo-wire traffic is lost until the pseudo-wire is established over an alternate LSP.

The diagram in FIG. 1 illustrates a VPLS topology 100 with 2 “sites” with a single pseudo-wire traversing from “site A” (connected to x670 PE on the left) to “site B” (connected to x670 Stack PE on the right) over a core MPLS network comprising of network switching nodes, such as Extreme Networks BDX8 network switching nodes. In the rest of the description “site A” refers to the site connected to the x670 PE on the left and “site B” refers to the site connected to the x670 Stack on the right. As illustrated, packets from “site A” to “site B” traverse a single LSP established over the top half of the network, as indicated at 105.

### SUMMARY OF THE INVENTION

A first switch at a first edge of an MPLS network establishes a VPLS pseudo-wire over a plurality of label switched paths (LSPs) of the MPLS network that couple the first switch to a second switch at a second edge of the MPLS network. The first switch further load balances data to be transmitted across the VPLS pseudo-wire over the plurality of LSPs. The first switch accomplishes this by maintaining at a first table an indication that the VPLS pseudo-wire traffic is to be transmitted over the plurality of LSPs and further identifying in the first table a pointer to a second table maintaining a plurality of LSP entries corresponding to the respective plurality of LSPs. The first switch then identifies at the second table a pointer to a third table maintaining a plurality of entries, wherein each of the plurality of entries identifies a next hop index. The first switch receives a packet to be transmitted over the VPLS pseudo-wire, computes a hash value on at least one or more portions of the received packet, and selects one of the plurality of entries in the third table according to the computed hash value.

### BRIEF DESCRIPTION OF THE DRAWINGS

FIG. 1 illustrates a prior art MPLS pseudo-wire configuration.

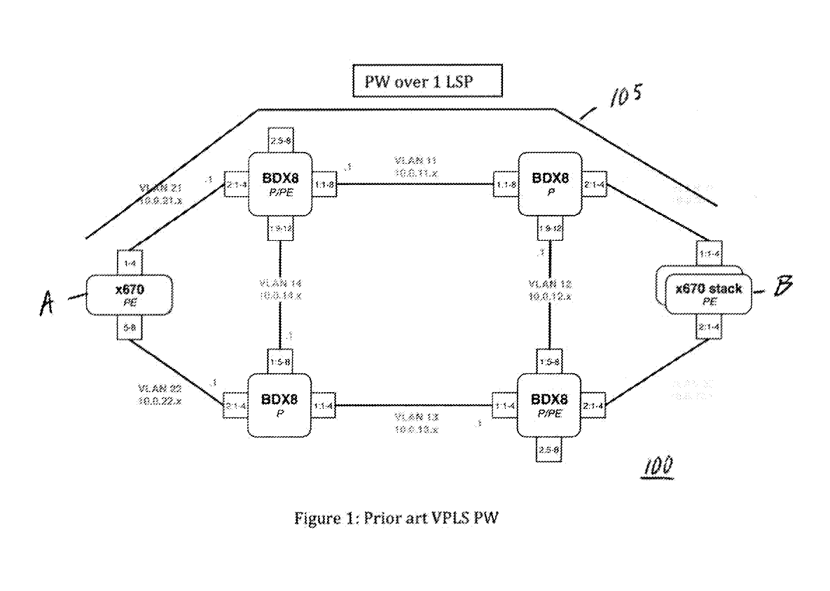

FIG. 2 illustrates a VPLS load-sharing network configuration.

FIG. 3 illustrates a VPLS load-sharing network configuration.

FIG. 4 illustrates an embodiment of the invention.

FIG. 5 illustrates an embodiment of the invention.

FIG. 6 illustrates a flow chart of an embodiment of the invention.

### DETAILED DESCRIPTION

Embodiments of the invention disclosed herein are referred to as pseudo-wire label switched paths (LSP) Load Sharing, i.e. establishing a pseudo-wire over multiple LSPs and load balancing the pseudo-wire bound traffic over multiple LSPs. Embodiments of the invention presented here include an implementation, for example, on the following Broadcom chipsets: 5684x, 5685x and 5664x. The assignee of the present patent application considers the embodiments disclosed herein to be applicable to the following chipsets as well: 5634x, 5644x and 5654x. Embodiments of the invention have the following characteristics:

Ability for VPLS ingress nodes to distribute traffic over multiple LSPs thus allowing the whole network to distribute traffic.

Ability to establish VPLS pseudo-wires over multiple LSPs thus allowing for better resiliency during network transitions. A particular LSP or path going down does not cause the pseudo-wire to be re-established or re-routed. The pseudo-wire continues to operate over the remaining LSPs on which it is established.

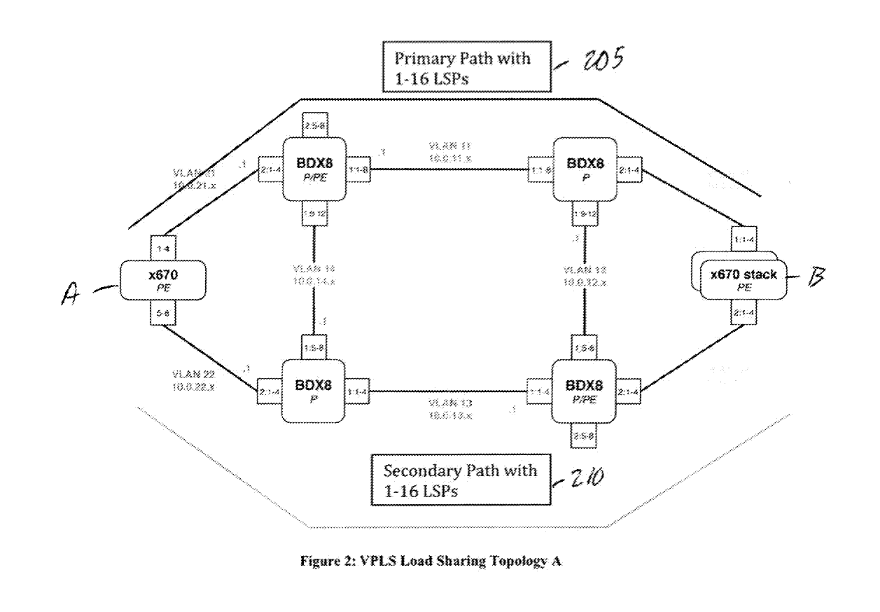

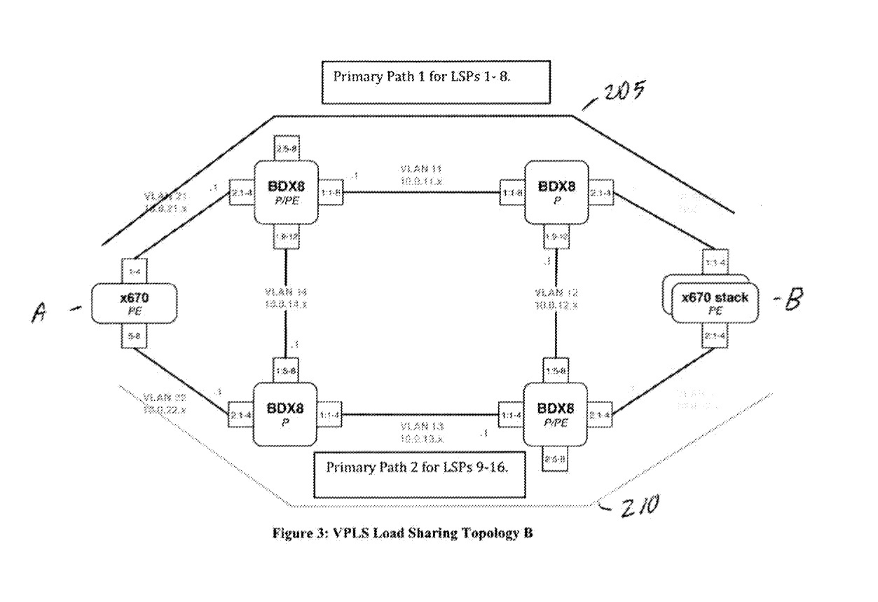

Referring to FIGS. 2 and 3, a VPLS pseudo-wire is established from site-A to site-B over the core MPLS network consisting of network switching nodes (BDX8) nodes. The pseudo-wires can be established over multiple LSPs that connects site A to site B. The links that connect the x670 at site A to the BDX8 at site B could be a single port or a link aggregation port (LAG) according to different embodiments.

In FIGS. 2 and 3, there are 2 LSP Paths shown, 205 and 210. In normal operating conditions, the LSPs follow the Primary Path 205. If there is a failure in the Primary Path, the Ingress Node detects the failure in the Primary Path, and switches the LSPs to use the Secondary Path 210. Upon restoration of the Primary Path, the Ingress Node switches the LSPs to revert back to the Primary Path.

In FIG. 2, the Primary Path for all of the LSPs are pinned to the top of the network, with the Secondary Path for all of the LSPs pinned to the bottom of the network. In this configuration, with both LSP Paths operational, all PW traffic traverses across the top of the network, along the Primary Path. If a failure occurs in the Primary Path, all PW traffic is switched to the Secondary Path, with minimal interruption to PW traffic. When the Primary Path is restored, all PW traffic reverts to the Primary Path, again with minimal interruption to PW traffic.

In FIG. 3, half of the LSPs (1-8) are pinned to the top of the network along Primary Path 1, and half of the LSPs (9-16) are pinned to the bottom of the network along Primary Path 2. In this configuration, with both LSP Paths operational, half of the PW traffic traverses the top of the network via the Primary Path 1 (LSPs 1-8), and half of the PW traffic traverses the bottom of the network via the Primary Path 2 (LSPs 9-16). Upon failure of the Primary Path 1 (LSPs 1-8), the PW traffic that normally traverses the top of the network switches to using Secondary Path 2 along the bottom of the network. In this failure mode, all of the PW traffic traverses the bottom of the network. Upon restoration of Primary Path 1, PW traffic for LSPs 1-8 reverts back to Primary Path 1.

If there is a failure in Primary Path 2 (LSPs 9-16), the PW traffic switches to using Secondary Path 1, along the top of the network. In this failure condition, all of the PW traffic traverses the top of the network. Upon restoration of Primary Path 2, PW traffic for LSPs 9-16 reverts back to Primary Path 2.

One embodiment of the invention disclosed herein is the implementation of the above feature on, for example, Broadcom hardware.

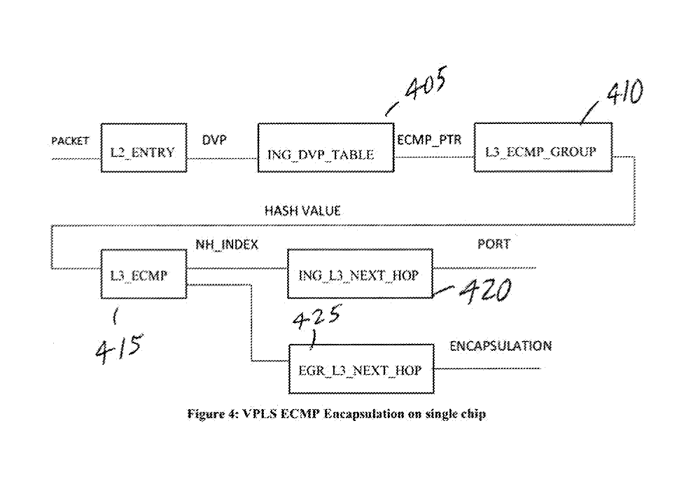

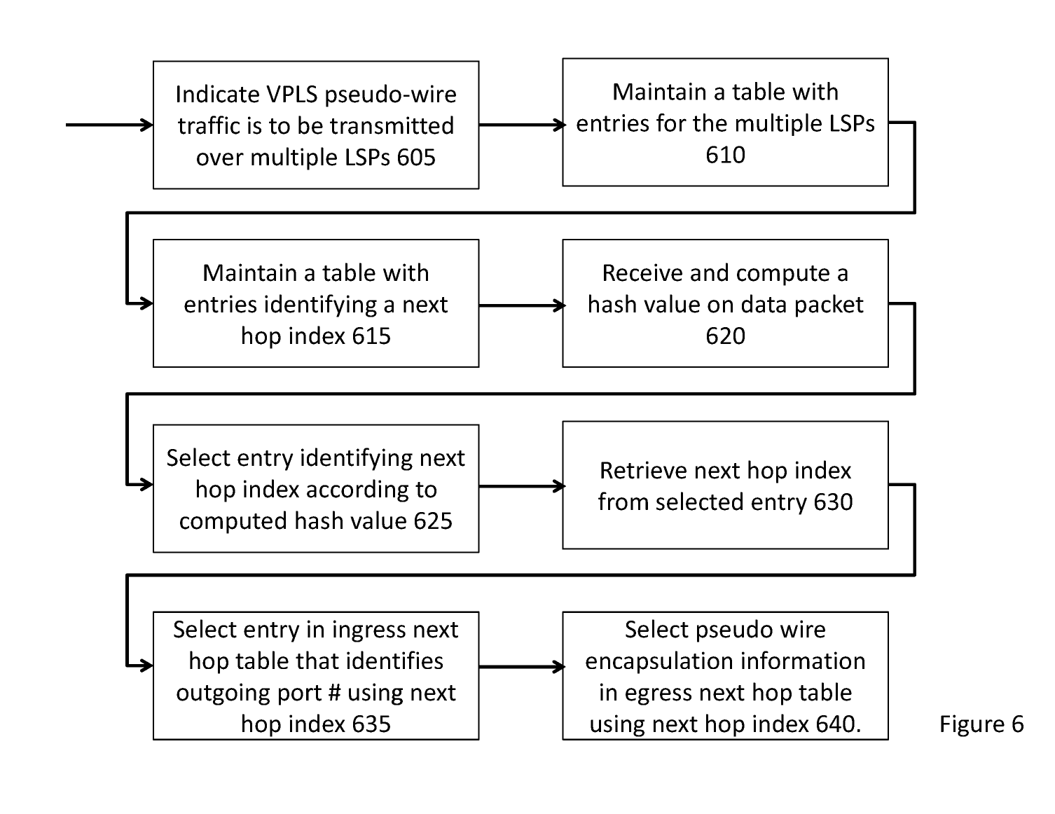

With reference to FIGS. 4 and 6, the Broadcom chips mentioned above have a first table 405, a Destination Virtual Port Table (ING_DVP_TABLE 405), that can be programmed at 605 to use multiple LSPs for a pseudo-wire. This table is programmed with an indication (ECMP=1) that multiple LSPs are in use and also programmed at 610 with a pointer to a second table 410 that indicates multiple LSPs in use (L3_ECMP_GROUP table 410). The L3_ECMP_GROUP table 410 has a base pointer to a third table (L3_ECMP table 415) maintained at 615 that contains a collection of entries, each of which specifies a single NEXT_HOP index. Using the RTAG7 hash engine, a hash value is computed at 620 on each received packet that is used as an index into the L3_ECMP table to select at 625 one of these NEXT_HOP Indices. The NEXT_HOP Index is retrieved at 630 and used at 635 as an index into a fourth table 420 (ING_L3_NEXT_HOP table 420) that provides the outgoing port. The same NEXT_HOP is also used at 640 as an index into a fifth table (EGR_L3_NEXT_HOP table 425) that provides pointers to the pseudo-wire encapsulation information.

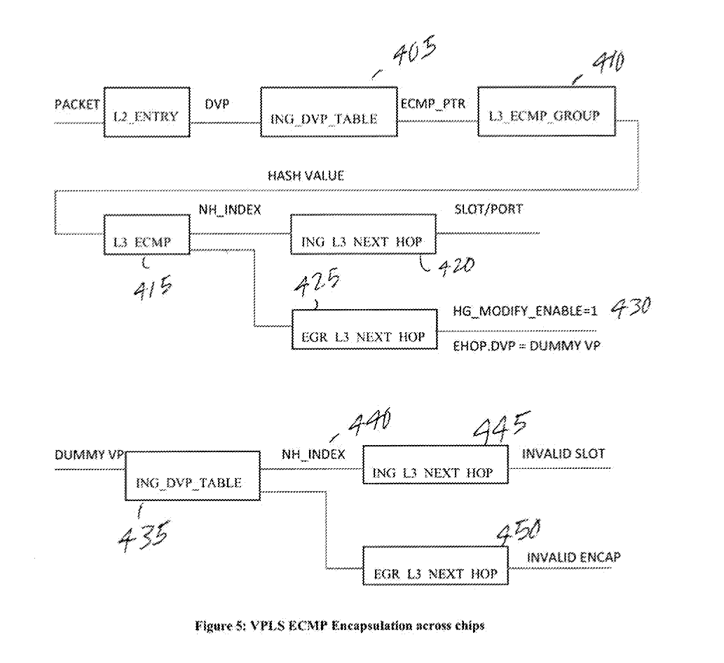

If the platforms built using these chips employ multiple chips (examples are Extreme Networks BDX8 Chassis, BD8K Chassis, x670 Stack), the ECMP pointer value programmed in the Destination Virtual Port table 405 has a non-zero value. When VPLS does not use ECMP, the VPLS encapsulation happens on the egress chip. But with ECMP, the egress chip is unable to do VPLS encapsulation, so the encapsulation is done by the ingress chip. This is accomplished by setting EGR_L3_NEXT_HOP.HG_MODIFY_ENABLE=1 at 430, as illustrated in FIG. 5.

According to one embodiment, and with reference to FIG. 5, even if HG_MODIFY_ENABLE is specified, the egress chip performs a lookup of ING_DVP_TABLE using the virtual port (VP) passed in the HIGIG header. The value obtained from this lookup is treated as NEXT_HOP_INDEX even if the value is in fact ECMP_PTR and ING_DVP_TABLE.ECMP=1 is set. To prevent this from happening, a dummy VP is created at 435 that has its slot, port and encapsulation information pointing at 440 to invalid values on the egress chip at 445 and 450. The ingress chip passes this dummy VP in the HIGIG header by setting EGR_L3_NEXT_HOP.DVP=DUMMY VP.

Load balancing and Traffic distribution is achieved by using RTAG7 registers present on these chips for use by another Broadcom feature referred to as TRILL. Embodiments of the invention use the same registers used by TRILL for achieving traffic distribution for VPLS pseudo-wires. The following registers are set.
HASH_CONTROL.ECMP_HASH_USE_RTAG7=1
RTAG7_HASH_TRILL_ECMP.SUB_SEL=1

The above settings work in conjunction with RTAG7 packet field selector registers to provide traffic distribution. Embodiments of the invention with respect to load balancing using RTAG7 registers makes use of TRILL RTAG7 registers for VPLS load balancing. TRILL and VPLS are completely different protocols. VPLS does not provide its own set of RTAG7 registers, but embodiments of the invention provide for VPLS to make use of TRILL RTAG7 registers.

Thus, disclosed are embodiments of the invention implemented in a first switch at a first edge of a multiprotocol label switching (MPLS) network, to allow the first switch to establish a virtual private local area network service (VPLS) pseudo-wire over a plurality of label switched paths (LSPs) of the MPLS network that couple the first switch to a second switch at a second edge of the MPLS network, and to load balance data to be transmitted across the VPLS pseudo-wire over the plurality of LSPs, the method comprising: maintaining at a first table an indication that the VPLS pseudo-wire traffic is to be transmitted over the plurality of LSPs and further identifying in the first table a pointer to a second table maintaining a plurality of LSP entries corresponding to the respective plurality of LSPs, identifying at the second table a pointer to a third table maintaining a plurality of entries, wherein each of the plurality of entries identifies a next hop index; receiving a packet to be transmitted over the VPLS pseudo-wire; computing a hash value on at least one or more portions of the received packet; selecting one of the plurality of entries in the third table according to the computed hash value; and retrieving the next hop index from the selected one of the plurality of entries in the third table.

An embodiment further comprises the first switch selecting an entry in a fourth table according to the retrieved next hop index; and retrieving from the selected entry in the fourth table an egress port number associated with an egress port to which the received packet is to be directed for transmission across the VPLS pseudo-wire.

An embodiment further comprises the switch selecting an entry in a fifth table according to the retrieved next hop index; and retrieving from the selected entry in the fifth table instructions for encapsulating the received packet for transmission across the VPLS pseudo-wire.

In one embodiment, the first switch comprises an ingress chipset having an ingress port, and an egress chipset; wherein receiving the packet to be transmitted over the VPLS pseudo-wire comprises receiving the packet at the ingress port of the ingress chipset; and further comprising processing at the ingress chipset the retrieved instructions for encapsulating the received packet for transmission across the VPLS pseudo-wire.

One embodiment further comprises the switch maintaining an indication in the fifth table that the ingress chipset is to process the retrieved instructions for encapsulating the received packet for transmission across the VPLS pseudo-wire. In one embodiment, the switch maintains in the fifth table dummy information for an egress port number associated with an egress port of the first switch to which the received packet is to be directed for transmission across the VPLS pseudo-wire; and provides the dummy information from the ingress chipset to the egress chipset.

In one embodiment, computing a hash value on at least one or more portions of the received packet comprises computing a hash value on at least one or more portions of the received packet using an RTAG7 hash engine and link state routing (Transparent Interconnection of Lots of Links (TRILL) RTAG7) registers. In another embodiment, computing a hash value on at least one or more portions of the received packet comprises selecting one or more of a plurality of TRILL RTAG7 hash value calculation modules according to the at least one or more portions of the received packet on which to compute the hash value.

In one embodiment, maintaining at the first table an indication that the VPLS pseudo-wire traffic is to be transmitted over the plurality of LSPs comprises maintaining at an ingress destination virtual port table the indication that the VPLS pseudo-wire traffic is to be transmitted over the plurality of LSPs, and identifying in the first table a pointer to a second table maintaining a plurality of LSP entries corresponding to the respective plurality of LSPs comprises identifying in the first table a pointer to an equal cost multipath group table maintaining a plurality of LSP entries corresponding to the respective plurality of LSPs. Further, identifying at the second table a pointer to a third table maintaining a plurality of entries comprises identifying at the second table a pointer to an equal cost multiple path (ECMP) table maintaining a plurality of equal cost multiple path (ECMP) entries, selecting an entry in a fourth table according to the retrieved next hop index comprises selecting an entry in a next hop table according to the retrieved next hop index; and retrieving from the selected entry in the fourth table an egress port number associated with an egress port to which the received packet is to be directed for transmission across the VPLS pseudo-wire further comprises retrieving from the selected entry in the fourth table an egress port number associated with an egress slot to which the received packet is to be directed for transmission across the VPLS pseudo-wire.

According to one embodiment, retrieving from the selected entry in the fifth table instructions for encapsulating the received packet for transmission across the VPLS pseudo-wire comprises retrieving from the selected entry in the fifth table a pointer to a location maintained in a memory of the first switch at which is stored instructions for encapsulating the received packet for transmission across the VPLS pseudo-wire.

Additional embodiments further contemplate detecting a failure of at least one of the plurality of label switched paths (LSPs) of the MPLS network; reconfiguring the plurality of LSPs of the MPLS network responsive to detecting the failure; and updating the second table maintaining the plurality of LSP entries corresponding to the respective reconfigured plurality of LSPs.

1. A method, in a first switch at a first edge of a multiprotocol label switching (MPLS) network, to establish a virtual private local area network service (VPLS) pseudo-wire over a plurality of label switched paths (LSPs) of the MPLS network that couple the first switch to a second switch at a second edge of the MPLS network, and to load balance data to be transmitted across the VPLS pseudo-wire over the plurality of LSPs, the method comprising:
maintaining at a first table an indication that the VPLS pseudo-wire traffic is to be transmitted over the plurality of LSPs and further identifying in the first table a pointer to a second table maintaining a plurality of LSP entries corresponding to the respective plurality of LSPs,
identifying at the second table a pointer to a third table maintaining a plurality of entries, wherein each of the plurality of entries identifies a next hop index;
receiving a packet to be transmitted over the VPLS pseudo-wire;
computing a hash value on at least one or more portions of the received packet;
selecting one of the plurality of entries in the third table according to the computed hash value; and
retrieving the next hop index from the selected one of the plurality of entries in the third table.

2. The method of claim 1, further comprising:
selecting an entry in a fourth table according to the retrieved next hop index; and
retrieving from the selected entry in the fourth table an egress port number associated with an egress port to which the received packet is to be directed for transmission across the VPLS pseudo-wire.

3. The method of claim 2, further comprising:
selecting an entry in a fifth table according to the retrieved next hop index; and
retrieving from the selected entry in the fifth table instructions for encapsulating the received packet for transmission across the VPLS pseudo-wire.

4. The method of claim 3,
wherein the first switch comprises an ingress chipset having an ingress port, and an egress chipset;
wherein receiving the packet to be transmitted over the VPLS pseudo-wire comprises receiving the packet at the ingress port of the ingress chipset; and
further comprising processing at the ingress chipset the retrieved instructions for encapsulating the received packet for transmission across the VPLS pseudo-wire.

5. The method of claim 4, further comprising maintaining an indication in the fifth table that the ingress chipset is to process the retrieved instructions for encapsulating the received packet for transmission across the VPLS pseudo-wire.

6. The method of claim 5, further comprising:
maintaining in the fifth table dummy information for an egress port number associated with an egress port of the first switch to which the received packet is to be directed for transmission across the VPLS pseudo-wire; and
providing the dummy information from the ingress chipset to the egress chipset.

7. The method of claim 1, wherein computing a hash value on at least one or more portions of the received packet comprises computing a hash value on at least one or more portions of the received packet using an RTAG7 hash engine and link state routing (Transparent Interconnection of Lots of Links (TRILL) RTAG7) registers.

8. The method of claim 7, wherein computing a hash value on at least one or more portions of the received packet comprises selecting one or more of a plurality of TRILL RTAG7 hash value calculation modules according to the at least one or more portions of the received packet on which to compute the hash value.

9. The method of claim 2, wherein maintaining at the first table an indication that the VPLS pseudo-wire traffic is to be transmitted over the plurality of LSPs comprises maintaining at an ingress destination virtual port table the indication that the VPLS pseudo-wire traffic is to be transmitted over the plurality of LSPs,
wherein identifying in the first table a pointer to a second table maintaining a plurality of LSP entries corresponding to the respective plurality of LSPs comprises identifying in the first table a pointer to an equal cost multipath group table maintaining a plurality of LSP entries corresponding to the respective plurality of LSPs,
wherein identifying at the second table a pointer to a third table maintaining a plurality of entries comprises identifying at the second table a pointer to an equal cost multiple path (ECMP) table maintaining a plurality of equal cost multiple path (ECMP) entries,
wherein selecting an entry in a fourth table according to the retrieved next hop index comprises selecting an entry in a next hop table according to the retrieved next hop index; and
wherein retrieving from the selected entry in the fourth table an egress port number associated with an egress port to which the received packet is to be directed for transmission across the VPLS pseudo-wire further comprises retrieving from the selected entry in the fourth table an egress port number associated with an egress slot to which the received packet is to be directed for transmission across the VPLS pseudo-wire.

10. The method of claim 3, wherein retrieving from the selected entry in the fifth table instructions for encapsulating the received packet for transmission across the VPLS pseudo-wire comprises retrieving from the selected entry in the fifth table a pointer to a location maintained in a memory of the first switch at which is stored instructions for encapsulating the received packet for transmission across the VPLS pseudo-wire.

11. The method of claim 1, further comprising:
detecting a failure of at least one of the plurality of label switched paths (LSPs) of the MPLS network;
reconfiguring the plurality of LSPs of the MPLS network responsive to detecting the failure; and
updating the second table maintaining the plurality of LSP entries corresponding to the respective reconfigured plurality of LSPs.

12. A computer-readable, non-transitory, storage medium, comprising computer instructions, that when executed, cause a first switch at a first edge of a multiprotocol label switching (MPLS) network, to establish a virtual private local area network service (VPLS) pseudo-wire over a plurality of label switched paths (LSPs) of the MPLS network that couple the first switch to a second switch at a second edge of the MPLS network, and to load balance data to be transmitted across the VPLS pseudo-wire over the plurality of LSPs, according to a method comprising:
maintaining at a first table an indication that the VPLS pseudo-wire traffic is to be transmitted over the plurality of LSPs and further identifying in the first table a pointer to a second table maintaining a plurality of LSP entries corresponding to the respective plurality of LSPs,
identifying at the second table a pointer to a third table maintaining a plurality of entries, wherein each of the plurality of entries identifies a next hop index;
receiving a packet to be transmitted over the VPLS pseudo-wire;
computing a hash value on at least one or more portions of the received packet;
selecting one of the plurality of entries in the third table according to the computed hash value; and
retrieving the next hop index from the selected one of the plurality of entries in the third table.

13. The computer readable medium of claim 12, further comprising executable instructions for:
selecting an entry in a fourth table according to the retrieved next hop index; and
retrieving from the selected entry in the fourth table an egress port number associated with an egress port to which the received packet is to be directed for transmission across the VPLS pseudo-wire.

14. The computer readable medium of claim 13, further comprising executable instructions for:
selecting an entry in a fifth table according to the retrieved next hop index; and
retrieving from the selected entry in the fifth table instructions for encapsulating the received packet for transmission across the VPLS pseudo-wire.

15. The computer readable medium of claim 14, further comprising executable instructions for:
wherein the first switch comprises an ingress chipset having an ingress port, and an egress chipset;
wherein receiving the packet to be transmitted over the VPLS pseudo-wire comprises receiving the packet at the ingress port of the ingress chipset; and
further comprising processing at the ingress chipset the retrieved instructions for encapsulating the received packet for transmission across the VPLS pseudo-wire.

16. The computer readable medium of claim 15, further comprising executable instructions for maintaining an indication in the fifth table that the ingress chipset is to process the retrieved instructions for encapsulating the received packet for transmission across the VPLS pseudo-wire.

17. The computer readable medium of claim 15, further comprising executable instructions for:
maintaining in the fifth table dummy information for an egress port number associated with an egress port of the first switch to which the received packet is to be directed for transmission across the VPLS pseudo-wire; and
providing the dummy information from the ingress chipset to the egress chipset.

18. The computer readable medium of claim 12, wherein the executable instructions for computing a hash value on at least one or more portions of the received packet comprise executable instructions for computing a hash value on at least one or more portions of the received packet using an RTAG7 hash engine and link state routing (Transparent Interconnection of Lots of Links (TRILL) RTAG7) registers.

19. The computer readable medium of claim 18, wherein the executable instructions for computing a hash value on at least one or more portions of the received packet comprise executable instructions for selecting one or more of a plurality of TRILL RTAG7 hash value calculation modules according to the at least one or more portions of the received packet on which to compute the hash value.

20. The computer readable medium of claim 13,
wherein the executable instructions for maintaining at the first table an indication that the VPLS pseudo-wire traffic is to be transmitted over the plurality of LSPs comprise executable instructions for maintaining at an ingress destination virtual port table the indication that the VPLS pseudo-wire traffic is to be transmitted over the plurality of LSPs,
wherein the executable instructions for identifying in the first table a pointer to a second table maintaining a plurality of LSP entries corresponding to the respective plurality of LSPs comprise executable instructions for identifying in the first table a pointer to an equal cost multipath group table maintaining a plurality of LSP entries corresponding to the respective plurality of LSPs,
wherein the executable instructions for identifying at the second table a pointer to a third table maintaining a plurality of entries comprise executable instructions for identifying at the second table a pointer to an equal cost multiple path (ECMP) table maintaining a plurality of equal cost multiple path (ECMP) entries,
wherein the executable instructions for selecting an entry in a fourth table according to the retrieved next hop index comprise executable instructions for selecting an entry in a next hop table according to the retrieved next hop index; and
wherein the executable instructions for retrieving from the selected entry in the fourth table an egress port number associated with an egress port to which the received packet is to be directed for transmission across the VPLS pseudo-wire further comprise executable instructions for retrieving from the selected entry in the fourth table an egress port number associated with an egress slot to which the received packet is to be directed for transmission across the VPLS pseudo-wire.

21. The computer readable medium of claim 14, wherein the executable instructions for retrieving from the selected entry in the fifth table instructions for encapsulating the received packet for transmission across the VPLS pseudo-wire comprise executable instructions for retrieving from the selected entry in the fifth table a pointer to a location maintained in a memory of the first switch at which is stored instructions for encapsulating the received packet for transmission across the VPLS pseudo-wire.

22. The computer readable medium of claim 13, further comprising executable instructions for:
detecting a failure of at least one of the plurality of label switched paths (LSPs) of the MPLS network;
reconfiguring the plurality of LSPs of the MPLS network responsive to detecting the failure; and
updating the second table maintaining the plurality of LSP entries corresponding to the respective reconfigured plurality of LSPs.

23. A switch at a first edge of a multiprotocol label switching (MPLS) network, to establish a virtual private local area network service (VPLS) pseudo-wire over a plurality of label switched paths (LSPs) of the MPLS network that couple the switch to a second switch at a second edge of the MPLS network, and to load balance data to be transmitted across the VPLS pseudo-wire over the plurality of LSPs, the switch comprising:
a first table to maintain an indication that the VPLS pseudo-wire traffic is to be transmitted over the plurality of LSPs and further to identify a pointer to a second table to maintain a plurality of LSP entries corresponding to the respective plurality of LSPs,
the second table to identify a pointer to a third table to maintain a plurality of entries, wherein each of the plurality of entries identifies a next hop index;
an input port to receive a packet to be transmitted over the VPLS pseudo-wire;
a hash engine to compute a hash value on at least one or more portions of the received packet; and
a first selection means to select one of the plurality of entries in the third table according to the computed hash value.

24. The apparatus of claim 23, wherein the first selection means further to retrieve the next hop index from the selected one of the plurality of entries in the third table; and
further comprising a second selection means to select an entry in a fourth table according to the retrieved next hop index and retrieve from the selected entry in the fourth table an egress port number associated with an egress port to which the received packet is to be directed for transmission across the VPLS pseudo-wire.

25. The switch of claim 24, further comprising:
a third selection means to select an entry in a fifth table according to the retrieved next hop index and retrieve from the selected entry in the fifth table instructions for encapsulating the received packet for transmission across the VPLS pseudo-wire.

26. The switch of claim 25, further comprising:
an ingress chipset having an ingress port and a processor;
an egress chipset coupled to the ingress chipset;
wherein the input port to receive a packet to be transmitted over the VPLS pseudo-wire comprises the ingress port of the ingress chipset to receive the packet to be transmitted over the VPLS pseudo-wire; and
the processor to encapsulate the received packet for transmission across the VPLS pseudo-wire according to the retrieved instructions.

27. The switch of claim 26, further comprising a fifth table to maintain an indication that the ingress chipset is to process the retrieved instructions to encapsulate the received packet for transmission across the VPLS pseudo-wire.

28. The switch of claim 27, further comprising:
the fifth table to maintain dummy information for an egress port number associated with an egress port of the first switch to which the received packet is to be directed for transmission across the VPLS pseudo-wire; and
the ingress chipset to provide the dummy information to the egress chipset.

29. The switch of claim 24, wherein the hash engine to compute a hash value on at least one or more portions of the received packet comprises an RTAG7 hash engine to compute the hash value on at least one or more portions of the received packet using Transparent Interconnection of Lots of Links (TRILL) RTAG7 registers.

30. The switch of claim 24,
wherein the first table to maintain an indication that the VPLS pseudo-wire traffic is to be transmitted over the plurality of LSPs comprises an ingress destination virtual port table to maintain the indication that the VPLS pseudo-wire traffic is to be transmitted over the plurality of LSPs,
wherein the first table to identify a pointer to a second table to maintain a plurality of LSP entries corresponding to the respective plurality of LSPs comprise the first table to identify a pointer to an equal cost multipath group table to maintain a plurality of LSP entries corresponding to the respective plurality of LSPs,
wherein the second table to identify a pointer to a third table to maintain a plurality of entries comprises the second table to identify a pointer to an equal cost multiple path (ECMP) table to maintain a plurality of equal cost multiple path (ECMP) entries,
wherein the first selection means to select an entry in a fourth table according to the retrieved next hop index comprises first selection means to select an entry in a next hop table according to the retrieved next hop index; and
wherein the second selection means to retrieve from the selected entry in the fourth table an egress port number associated with an egress port to which the received packet is to be directed for transmission across the VPLS pseudo-wire further comprises the second selection means to retrieve from the selected entry in the fourth table an egress port number associated with an egress slot to which the received packet is to be directed for transmission across the VPLS pseudo-wire.

31. The switch of claim 25, wherein the third selection means to retrieve from the selected entry in the fifth table instructions encapsulate the received packet for transmission across the VPLS pseudo-wire comprises third selection means to retrieve from the selected entry in the fifth table a pointer to a location maintained in a memory of the first switch at which is stored instructions to encapsulate the received packet for transmission across the VPLS pseudo-wire.

32. The switch of claim 24, further comprising:
detection means to detect a failure of at least one of the plurality of label switched paths (LSPs) of the MPLS network;
reconfiguration means to reconfigure the plurality of LSPs of the MPLS network responsive to detecting the failure; and
wherein the second table to update the maintained plurality of LSP entries corresponding to the respective reconfigured plurality of LSPs.
